(19) United States
(12) Patent Application Publication
(10) Pub. No.: US 2007/0100515 A1
(43) Pub. Date: May 3, 2007

(54) Full Flight Phase Video Familiarization

(76) Inventor: Donald H. McClure, Marshall, VA (US)

Correspondence Address: MILES & STOCKBRIDGE PC, 1751 PINNACLE DRIVE, SUITE 500, MCLEAN, VA, 22102-3833, US

(21) Appl. No.: 11/428,510

(22) Filed: Jul. 3, 2006

Related U.S. Application Data
(60) Provisional application No. 60/695,437, filed on Jul. 1, 2005.

(51) Int. Cl. G01C 23/00

(52) U.S. Cl. 701/3

(57) ABSTRACT

A video familiarization tool and method for using such a tool and of making the same. The video familiarization tool, in an exemplary embodiment, may include a computer generated simulation video that allows a vehicle operator, such as a pilot, to become familiar with surroundings, topography, man-made structures, and procedures related to a route of travel that the operator may be required to operate the vehicle in.

### RELATED APPLICATIONS

This application claims the benefit of priority under 35 U.S.C. §119(e), and any other applicable provisions, to U.S. Provisional Patent Application No. 60/695,437, filed on Jul. 1, 2005, and entitled “Full Flight Phase Video Familiarization”, which is incorporated herein by reference in its entirety.

### FIELD OF THE INVENTION

An exemplary embodiment of the present invention relates generally to visual aids for operating aircraft and, more particularly, to a method and system for using video familiarization tools to assist pilots in identification of approaches to airports and methods of making video familiarization tools.

A vehicle operator, such as a commercial pilot, may be required to operate a vehicle in, or travel to, areas that are unfamiliar to him/her. In such instances, it would be advantageous to be able to familiarize the pilot, for example, with the surrounding area, the desired approach to a landing area and any procedures which may be required for traveling to or from that area. Prior familiarization of any special requirements such as terrain avoidance or special operating procedures for an area in which the pilot proposes to land a plane is essential for his safety and the safety of any passengers. A tool to familiarize a vehicle operator with visual aspects such as landscape terrain, manmade structures and the like helps reduce the likelihood of the operator becoming confused or surprised by unfamiliar surroundings, thus enabling the operator to concentrate more easily on landing procedures.

Flight simulators, such as, for example, Microsoft's Flight Simulator, and X-Plane, may provide realistic simulations, but they do not permit the visualization of a particular navigational procedure without input by a user. The present invention provides a familiarization video tool that may include a visual output of a flight simulator, but which does not require any knowledge of the flight simulator in order to become familiar with a navigational procedure and receive the benefit provided by the flight familiarization.

### SUMMARY

Generally, an exemplary embodiment of the present invention includes a video familiarization tool, a method for using such a tool, and a method of making the same. In an exemplary embodiment, the video familiarization tool includes a video that allows a vehicle operator to become familiar with surroundings and procedures of a prescribed route of travel that the vehicle operator may be required to operate the vehicle in. For example, commercial airline pilots may be required to fly to unfamiliar airports that have special terrain and/or operational requirements. Although the invention is described herein in terms of a full flight phase video familiarization for pilots of aircraft, it should be appreciated that an embodiment of the video familiarization tool could be used by operators of other types of vehicles and/or craft.

For example, familiarization video tools could be used by operators of surface vehicles such as cars, trucks, motorcycles, buses, bicycles and the like; as well as watercraft, such as ships, boats, submarines and the like; spacecraft such as rockets, shuttles, space stations, satellites and the like; or remote operated vehicles such as unmanned aerial vehicles (UAVs), remote operated submersibles, remotely piloted spacecraft, remotely operated robots, and remote operated terrestrial or space vehicles. Familiarization videos could be used to familiarize operators with terrain features or manmade structural features of an unfamiliar area. The video familiarization tool could also be used to familiarize operators of vehicles with areas that they may have previously been familiar with and which have undergone some change that now requires them to become familiar with the new aspect of operating the vehicle in that area. Familiarization tools may even be used to familiarize personnel with an area that they may be required to enter with in a vehicle, on foot, or via a combination of the above.

Although the exemplary video familiarization tool as described herein has particular advantages for pilots required to land at unfamiliar airports, the invention in its broader aspects could be used with any type of vehicle. In its application to piloted aircraft the invention is useful for commercial aviation purposes for flight phase familiarization (i.e. taxi, take off, climb, cruise, descent, and/or landing), approach familiarization, departure familiarization and ground operations familiarization. In addition, familiarization video tools according to the invention could be generated for taxi route familiarization, for surface operations, ground crew, mechanics and baggage handlers. Further, video familiarization tools according to the invention have application for general aviation airport and/or route familiarization in the full flight phase approach, departure and ground operations. In the case of general aviation, it may be advantageous to select the most traveled airways or airports and generate a prepackaged familiarization video for those airways or airports that are most traveled by general airmen.

Although the examples of embodiments of the invention described herein are based on generating a video of a flight plan or approach to an airport prior to flight for viewing by an aircraft pilot prior to flight, the video familiarization tool could be transmitted in real time to the aircraft, or stored on a computer in the aircraft or transmitted at some time before or during the flight to the pilot for viewing before, or during the flight, or during a particular procedure such as a final approach. Further, a video familiarization tool may be used after a flight to instruct a pilot, or vehicle operator, regarding a desired vehicle operating procedure. Video familiarizations may be included with the primary familiarization tool for diversion airports along the flight path route for extended twin engine operations (ETOPS). It should be appreciated that a pilot flying into a primary international airport such as, for example, San Diego, may not be familiar with diversion airports along the way that may have to be used in case of emergency.

The video familiarization tool of the present invention can be used in various forms and formats including VHS tape, CD ROM, DVD, web video delivered over a global network such as the Internet, broadcast via wireless cable, fiber optic, and/or the like. The method for generating a video familiarization as described herein has application for other purposes including accident incident, reconstruction and/or recreating a particular flight at a particular time in certain weather conditions.

One particular advantageous feature of the invention relates to a method of visually communicating a vehicle maneuver to a vehicle operator. The method comprises presenting the vehicle operator with an image of a prescribed route of travel including an indication of at least one of a heading, altitude, and speed appropriate for a prescribed route of travel of the vehicle. The vehicle operator is further provided with a computer-generated moving image having a vantage point inside the vehicle. The moving image shows or displays a computer simulation of the vehicle maneuver performed in accordance with the prescribed route of travel. A simulated instrument panel of the vehicle responsive to a change in a state of the vehicle based on the prescribed route of travel is shown to the vehicle operator.

In another particularly advantageous form of the invention, the vehicle operator is presented with a computer-generated moving image having a vantage point outside the vehicle and showing a vehicle maneuver performed in accordance with a prescribed route of travel. The moving image may include graphical or auditory cues indicating a portion of the prescribed route of travel that may present a difficulty to vehicle operators.

Another feature of the invention provides a method of making a simulated flight phase familiarization video. A simulated location and a simulated aircraft on a computer flight simulator is selected along with a route of travel associated with the simulated location. The route of travel includes a prescribed procedure comprising the steps of setting at least one of a position, altitude, heading, and airspeed of the simulated aircraft in accordance with the route of travel; providing input to the computer light simulator for executing the flight phase in accordance with the prescribed procedure; and recording a graphical output of the flight simulator as a digital moving image.

In accordance with a further feature of the invention the prescribed procedure is an approach to an airport or a departure from an airport wherein the input includes at least one of global positioning system coordinates, flight management system data, manual control through an input device, and autopilot settings. Other inputs may include a time of day and weather conditions.

Yet another feature of the invention includes creating a video using a movie editing tool, wherein the video includes a digital moving image or a still image and an audio narrative.

Yet a further feature of the invention is a familiarization tool for familiarizing a pilot with a flight phase of a prescribed route of travel, comprising a video recording of a video output of a computer simulation of the flight phase, wherein the computer simulation includes images corresponding to an input causing a simulated aircraft to execute the flight phase in accordance with the prescribed route of travel; and an audio recording, time-synchronized with the video recording, provides remarks relating to the flight phase, while a graphical image of the prescribed route of travel is displayed.

Another feature of the invention provides an approach or departure procedure for an airport that presents an indication of the difficulty or danger in the approach or departure from the airport and visual cues for the pilot are provided which the pilot may use as an aid in flying the prescribed route of travel.

### BRIEF DESCRIPTION OF THE DRAWINGS

A better understanding of the invention may be obtained from a reading of the following specification describing preferred embodiments, particularly when considered in light of the drawings herein, where:

FIG. 1 is a block diagram of an exemplary system to create video familiarization tools;

FIG. 2 is a flowchart showing an exemplary method of creating video familiarization tools;

FIG. 3 is a block diagram of an exemplary timeline of a flight familiarization video tool; and

FIGS. 4-12 show still pictures taken from an exemplary approach familiarization video tool.

### DETAILED DESCRIPTION

The video familiarization tool of the present invention provides a method of visually communicating a vehicle maneuver to a vehicle operator. The method includes presenting the vehicle operator with an image of a prescribed route of travel including an indication of at least one of a heading, altitude, and speed appropriate for the prescribed route of travel. The method also includes presenting the vehicle operator with a computer-generated moving image having a vantage point inside the vehicle, the moving image showing a computer simulation of the vehicle maneuver performed in accordance with the prescribed route of travel, and showing a simulated instrument panel of the vehicle responsive to a change in a state of the vehicle based on the prescribed route of travel. The vehicle operator may be presented with a different computer-generated moving image having a vantage point outside the vehicle and showing the vehicle maneuver performed in accordance with the prescribed route of travel.

The moving image may include graphical or auditory cues indicating a portion of the prescribed route of travel that presents a difficulty to vehicle operators, or that presents a point of interest or reference in operating the vehicle over the prescribed route. The image of the prescribed route of travel may include a portion of a navigational chart.

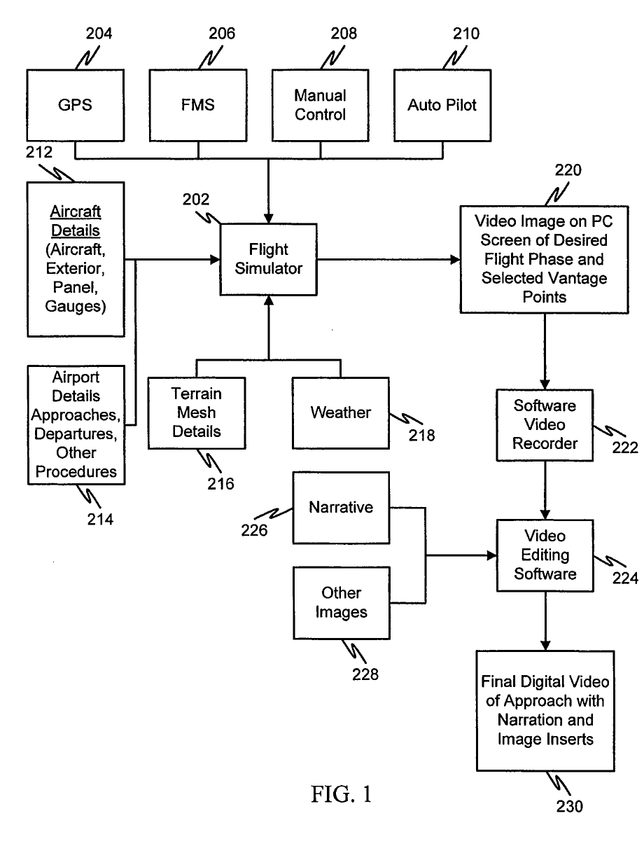

Referring to FIG. 1, there is illustrated an exemplary system for generating a full flight phase video familiarization tool. A flight simulator 202 receives control input via simulated GPS settings 204, a simulated flight management system (FMS) 206, manual control (such as through a keyboard, mouse, joystick, or other input device) 208, and/or simulated autopilot 210. The flight simulator 202 may also receive, as input, aircraft details including an aircraft type, an exterior paint scheme of the aircraft, an instrument panel of the aircraft. The flight simulator 202 may also receive, as input, airport details 214 including approaches, departures and other procedures, and beacons and other navigational elements such as airways and intersections. The flight simulator 202 may also receive, as input, terrain mesh details 216 and weather information 218. The weather information 218 may include computer generated weather data and/or actual weather data received in real time or recorded actual weather data. The flight stimulator 202 outputs video images on the screen of a computer 220. The video images 220 may be recorded on a software video recorder 222. The output of the software video recorder 222 is used as input into a video editing software program 224. The video editing software program 224 also receives optional narrative 226 and other images 228 used to form the final video familiarization 230. The video familiarization tool 230 may be in the form of a video media or electronic file, which has recorded therein video images generated by the flight simulator and any optional narration and/or other images such as navigational charts edited together into a video familiarization tool 230.

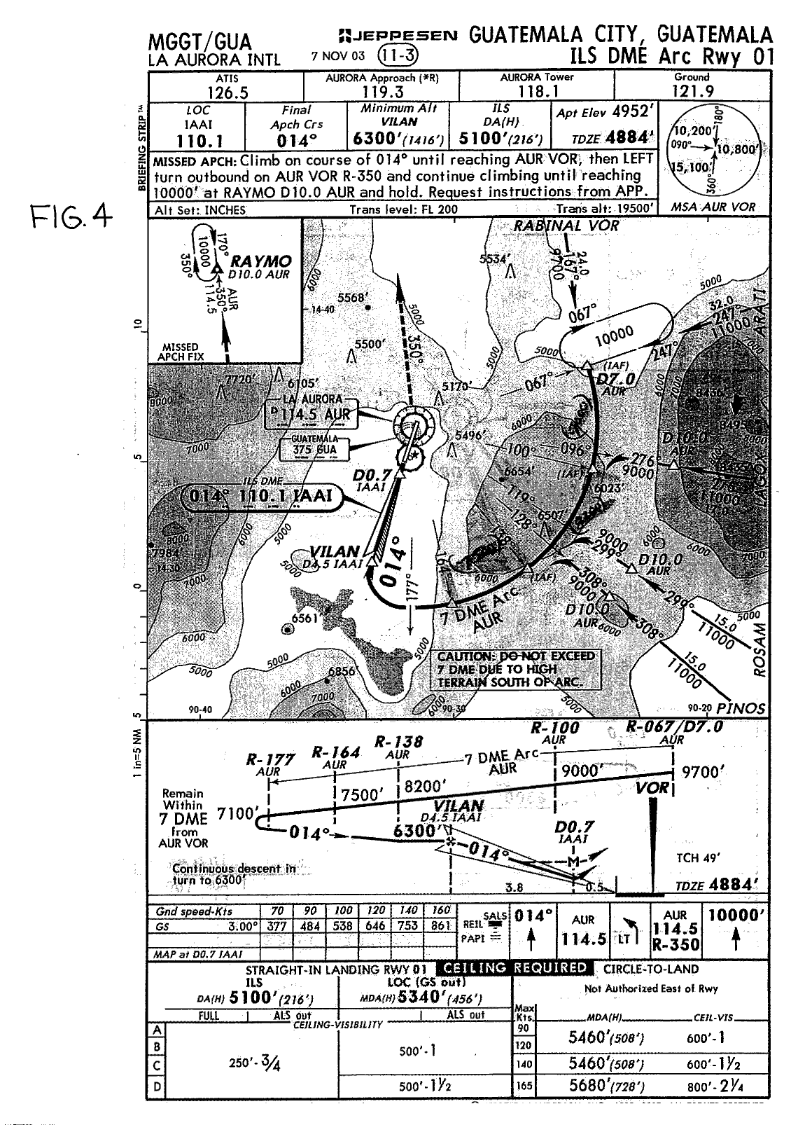

In operation, a user desiring to generate a video familiarization tool sequence, would direct flight simulator 202 to locate the simulated aircraft at a certain position with a specific altitude, heading, and air speed. Then, through one of the input methods GPS 204, FMS 206, manual control 208 or autopilot 210, cause the simulated aircraft to fly, for example, an approach to a designated airport in accordance with a route of travel prescribed by a navigational chart. The flight simulator 202, using the aircraft details 212, airport details 214, terrain mesh 216 and weather information 218, generates a realistic simulated image of the surrounding terrain or other structures as the simulated aircraft is being flown the prescribed route of travel. The flight simulator 202 may also generate images of the aircraft instruments responding to the simulated travel of the aircraft over the prescribed route of travel. This simulation of the surrounding terrain and/or aircraft instruments is displayed on the computer video screen and captured by the software video recorder 222. The flight simulator 202 may be used to generate a video of a particular procedure such as an approach from different vantage points such as the cockpit, a vantage point from outside the aircraft, a vantage point from the ground or a vantage point from any other chosen position. The videos of the approach are then edited together along with narration 226 and other images 228 using the video editing software program 224 to create the final output product which is the video familiarization of the airport and the approach 230. Images taken from an exemplary video familiarization tool are shown in FIGS. 4-12. In particular, there is shown a sequence of video screens showing a typical approach to the international airport at Guatemala City, Guatemala.

While a flight simulator is shown in the exemplary embodiment of FIG. 1, it should be appreciated that other computer software is useful to generate images such as mapping programs, graphic display programs, CAD programs, 3-D animation programs, 2-D animation programs. Any software capable of generating graphical images that would be useable for video familiarization is readily adaptable for use with this invention.

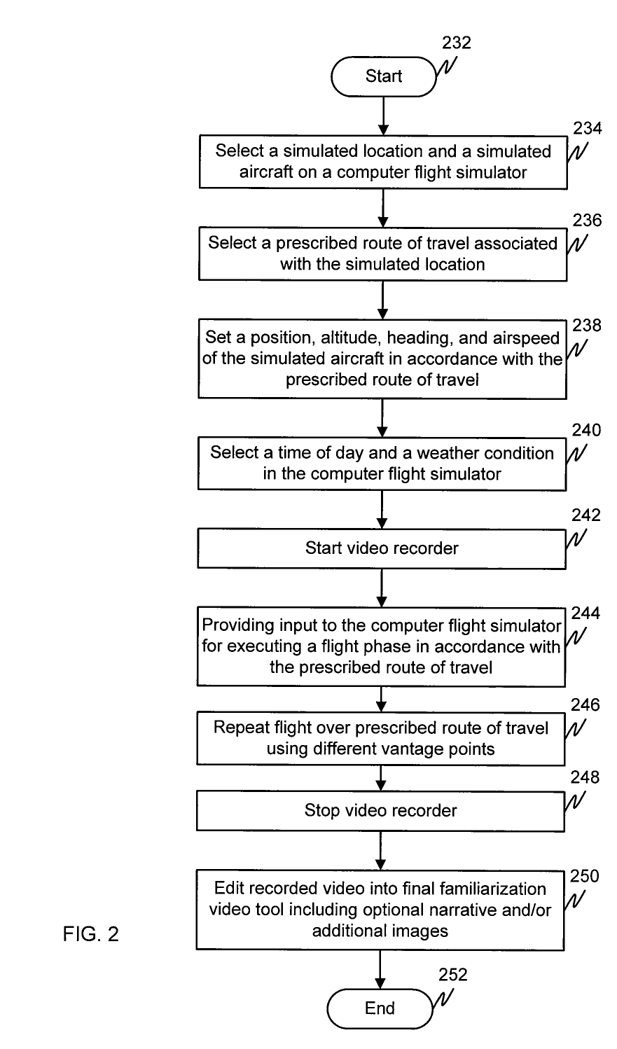

FIG. 2 shows a flow chart of an exemplary method for making a video familiarization tool for an airport approach. The sequence begins at step 232 and continues through step 252 when all desired information has been inputted and a video familiarization tool is created. After start (step 232), a simulated location and a simulated aircraft are selected on a computer flight simulator (step 234). The simulated location may include, for example, an airport, a navigational aid, or other point of interest to a pilot of an aircraft. Next, a prescribed route of travel associated with the simulated location is selected (step 236). Then, a position, altitude, heading, and/or airspeed of the simulated aircraft are set in the flight simulator (238). These parameters may be in accordance with the prescribed route of travel.

Optionally, a time of day, a date, and/or a weather condition are selected in the flight simulator (step 240). A video recorder, such as, for example, a software video recorder, is started (step 242). Input is provided to the flight simulator for executing a flight phase in accordance with the prescribed route of travel (step 244). Optionally, the flight phase may be repeated with the computer flight simulator showing the flight from different vantage points (step 246). After all flight phases from desired vantage points have been flown in the flight simulator and recorded, the video recorder is stopped (step 248).

The recorded video may be edited, using standard video editing techniques, into a final familiarization tool, optionally including audio and/or textual narrative and/or additional graphical images (step 250). The method ends at step 252. It should be appreciated that all or a portion of the method may be repeated as desired depending on a contemplated use of the invention. The additional images may include navigational charts, maps, pictures, and/or the like.

The above method has been described in terms of a user operating a simulated aircraft; however, it should be appreciated that aircraft or graphics generation program by providing data of an actual flight, providing pre-programmed data of simulated flight, providing GPS data and/or other navigational data or providing data of preprogrammed data of a navigational route and/or approach and departure procedures to the a program. In other words, the method could be automated or done manually using an operator to fly the simulated aircraft to generate the familiarization video. It should further be appreciated that simulated or actual recorded scenes could be used.

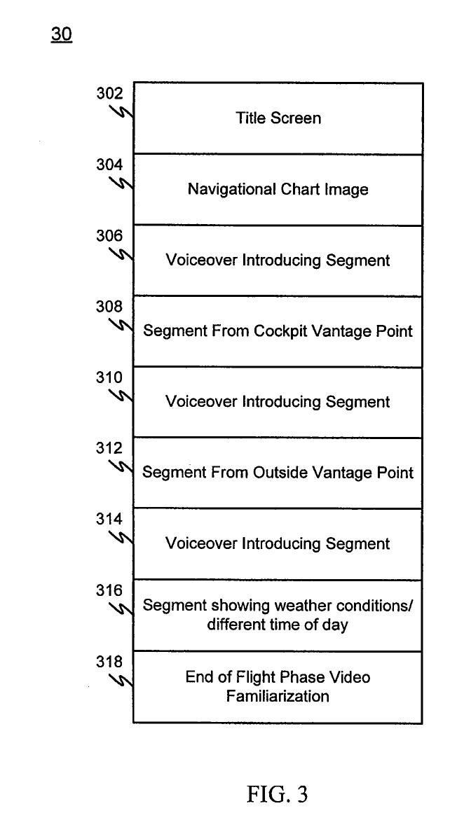

FIG. 3 shows an exemplary format of a video familiarization tool 30. In particular, the video familiarization tool 30 comprises a title screen 302, a navigational chart image 304, a voice over introducing a segment 306, a segment from the cockpit vantage point 308, a voice over introducing a next segment 310, a segment from outside vantage point 312, a voice over introducing a next segment 314, a segment showing varying weather and/or time of day conditions 316 and the end of the flight phase video familiarization 318, which is the end of the video.

The title screen 302 is used to convey information about what video familiarization the user will be viewing. The navigational chart image 304 is an optional image that can be included to further reinforce to a pilot or operator of a vehicle what they are about to see. For example, the navigational chart image may represent a map image of an approved instrument approach procedure including altitude, heading, and airspeed. The voiceover introducing a next segment 306 gives the pilot an audio cue describing what the pilot will see in the next video segment. The segment of video from the cockpit vantage point 308 shows the pilot a particular procedure or prescribed route of travel such as an approach from the cockpit vantage point of the aircraft that the pilot will be operating. It is important to note that the video familiarization is not intended to familiarize the pilot with the operation of the aircraft, but rather to familiarize the pilot with the surroundings in which the pilot will be operating the aircraft, and any special or unusual procedures associated therewith.

The voiceover introducing a next segment 310 introduces the upcoming segment of video for the pilot. The segment of video from outside vantage point 312 shows the approach procedure from a simulation vantage point outside the aircraft this may be useful for the pilot to provide for him a better understanding of the broader picture of the surrounding terrain and to view the aircraft operating from above or some other outside vantage point such that the pilot has a better appreciation for the area and allows him to identify certain danger points. The voiceover introducing the next segment 314 introduces the next segment 316 of video. The segment 316 showing different weather conditions and/or different time of day conditions is used, for example, to illustrate by video graphics what an unfamiliar airport looks like at night or in varying weather conditions such as when haze, smoke, fog, rain, snow, or the like may be present.

FIG. 4 shows an exemplary prescribed route of travel. IN particular, FIG. 4 shows an approved approach chart for Guatemala City, Guatemala.

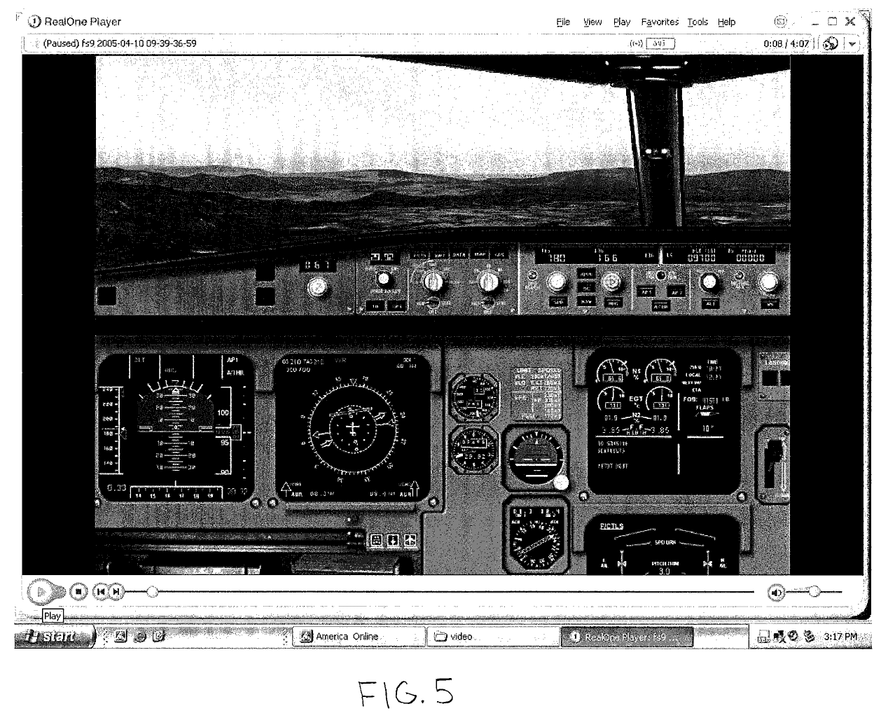

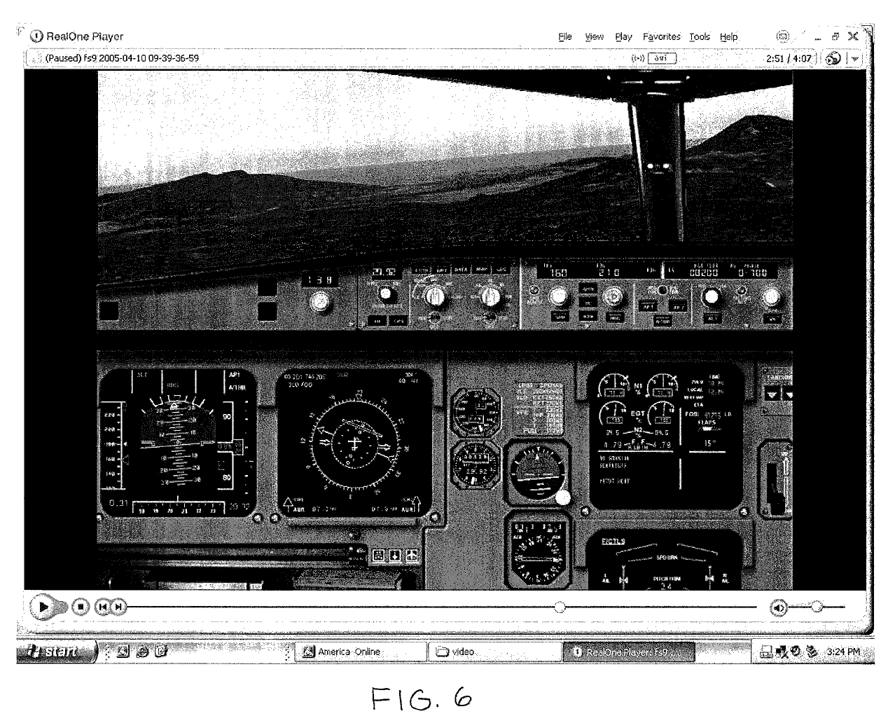

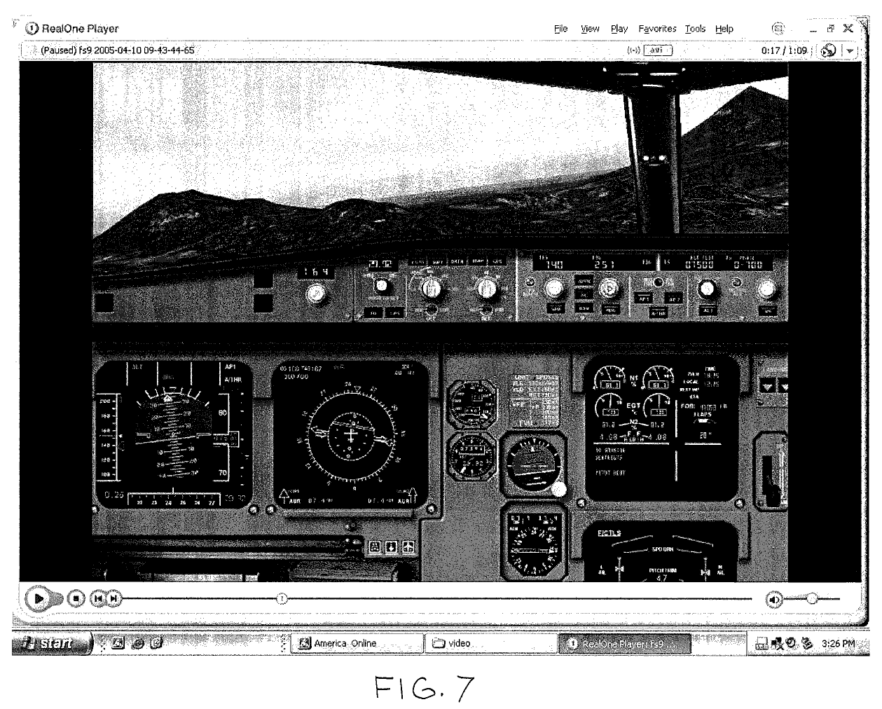

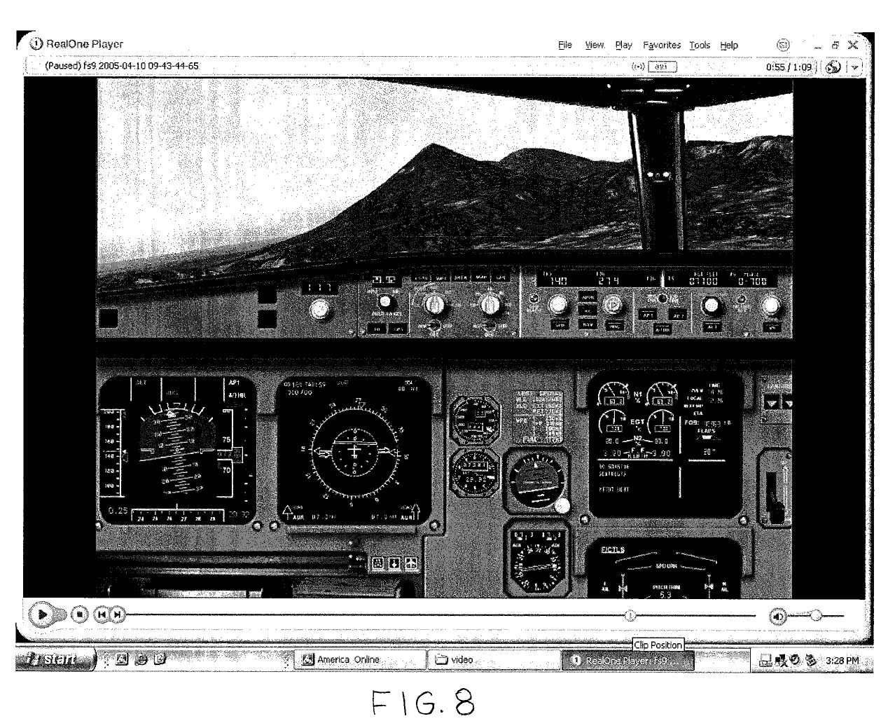

FIGS. 5-10 show a sequence of still pictures taken from an exemplary video familiarization tool showing an approach to the Guatemala City, Guatemala airport from the cockpit vantage point. In FIG. 6 a mountain can bee seen through the right side of the cockpit window. In FIGS. 7 and 8 the mountain moves across the cockpit field of view as the plane turns to the right to line up for final approach to the runway.

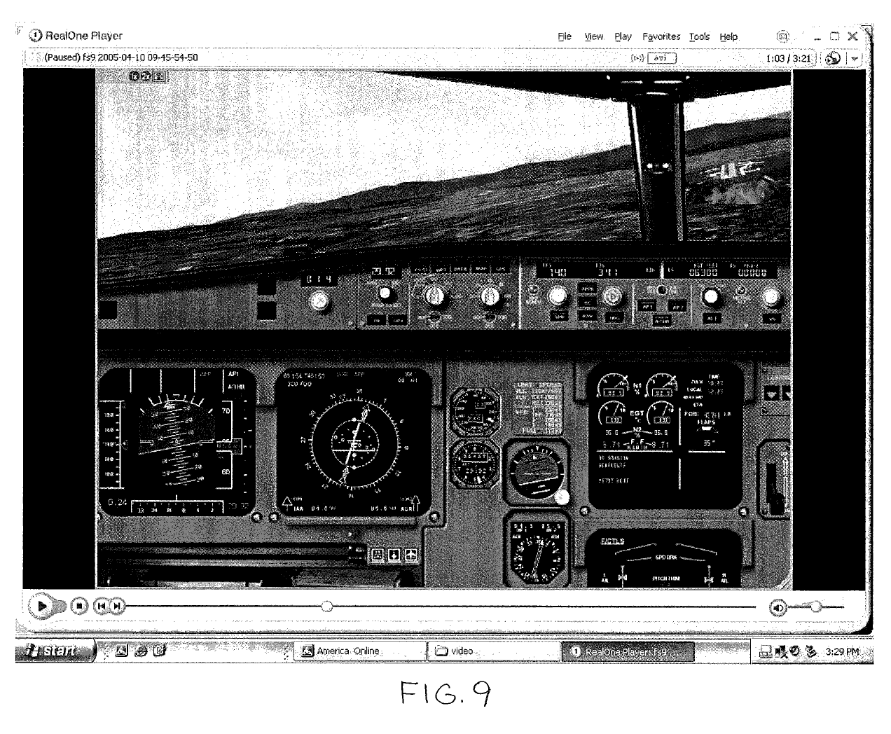

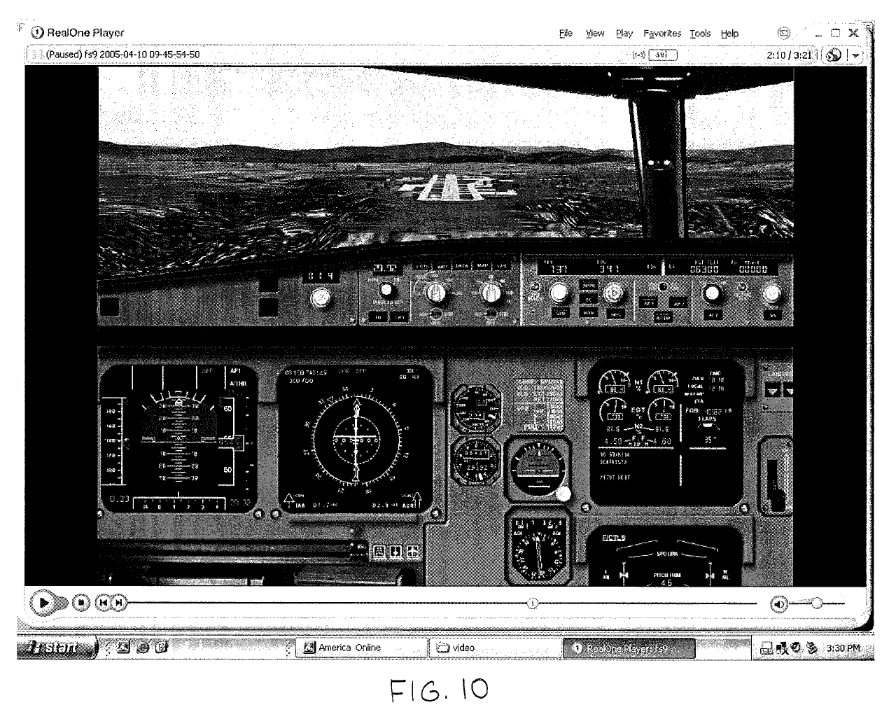

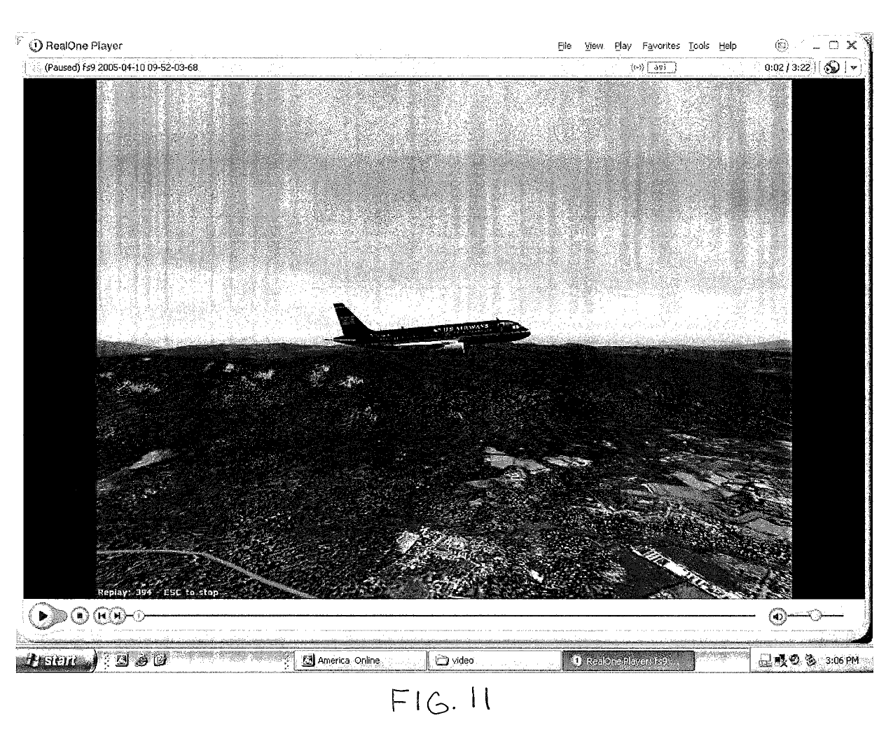

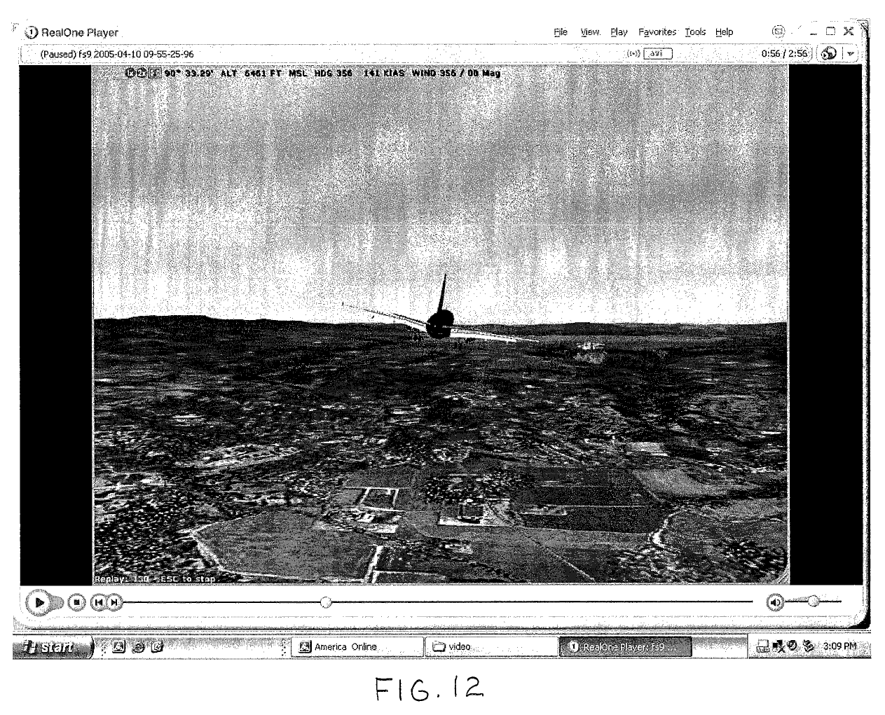

In FIG. 9 the runway can bee seen coming into view in the right side of the cockpit window. In FIG. 10 the plane is lined up for final approach for landing and the runway can bee seen in the center of the cockpit field of view. FIGS. 11 and 12 show views from outside of the plane as it flies the approach to Guatemala City, Guatemala airport.

In using a flight simulator to create a video familiarization record which may be a disc, tape or other medium, a flight within the flight simulator may be created first in which an aircraft is selected, a location is selected using an airport code, weather conditions are selected and time and date for the flight are selected. Next display settings may be configured such as for the scenery and/or aircraft. Next an input device may be calibrated such as a joystick for controlling the operation of flight simulator. The input device may be configured with various functions such as break release, landing gear, pitch trim up, pitch trim down, flaps extend, flaps retract, spoilers extend, and spoilers retract. The sensitivity of the input device may be configured as appropriate. Next, the aircraft in the simulator will be located for the procedure or flight phase being produced for the video familiarization using the map of the flight simulator the aircraft can be positioned using latitude and longitude coordinates also the aircraft heading, airspeed and altitude can be input into the flight simulator. Once the flight simulator program has been configured as described above, the flight simulator program may be paused or put on hold while the preparation for recording the flight video is made.

Video recording software is started and set to record the video produced by the flight simulator program. The flight simulator program is then unpaused or released from the hold it was in such that the aircraft now starts moving according to the settings entered into the flight simulator. The phase of flight being produced for the video familiarization is flown either manually or automatically and the images generated by the flight simulator programmer captured by the software video recorder. The flight simulator may have a feature to replay a flight segment or an entire flight that is flown, and in these replayed segments the vantage point can change such that once a flight phase or segment has been flown it may be reflown automatically using the replay feature of the simulator program while the changing the vantage points and recording the different vantage points views of the simulated segment of the software video recorder. Once the desired segments and vantage points have been generated by the flight simulator and recorded by the software video recorder, the software video recorder is then stopped and caused to generate a raw output video file. This raw output video file is then used as input into video editing software which can then be used to finalize the video product for the video familiarization tool. In the video editing stage narration may be added and/or other images such as navigational charts may be added as has been described above. The video editing software can produce a video in various compressed or uncompressed formats such as, for example, MPEG or DIVX that may be useful for transmitting and/or storing the final video familiarization tool. It should be appreciated that numerous video formats exist, and may be developed in the future, and any video format may be used with present invention. The output of the video editing software is the video familiarization tool which can be in the form of a VHS tape, a DVD, a CD ROM or stored electronically, for example, on a hard drive or in a memory of a computer for delivery over the Internet or delivery by some other wired, wireless, or storage medium means. The video familiarization tool can then be delivered to the operator of a vehicle before, during, or after the operation of the vehicle over the prescribed route of travel to familiarize the pilot with the surrounding area, any structural terrain features that the operator of the vehicle may need to be aware of, any required or desired operating methods, and/or any special, unusual or difficult procedures required by the prescribed route of travel.

It should be appreciated that the video familiarization system and tool and method for making the same as described herein can be used with the various types of vehicles for familiarizing an operator of the vehicle with manmade structures and natural occurring features of the layout and/or with various weather conditions and time of day conditions.

It should be appreciated that there is set forth herein a full flight phase video familiarization tool, and a method for making and using the same. Applicants intend to embrace all variations that are within the true spirit and full scope of this invention.

What is claimed is:

1. A method of visually communicating a vehicle maneuver to a vehicle operator, the method comprising:
presenting the vehicle operator with an image of a prescribed route of travel including an indication of at least one of a heading, altitude, and speed appropriate for the prescribed route of travel; and
presenting the vehicle operator with a computer-generated moving image having a vantage point inside the vehicle, the moving image showing a computer simulation of the vehicle maneuver performed in accordance with the prescribed route of travel, and showing a simulated instrument panel of the vehicle responsive to a change in a state of the vehicle based on the prescribed route of travel.

2. The method of claim 1, further comprising presenting the vehicle operator with a different computer-generated moving image having a vantage point outside the vehicle and showing the vehicle maneuver performed in accordance with the prescribed route of travel.

3. The method of claim 1, wherein the moving image includes graphical or auditory cues indicating a portion of the prescribed route of travel that presents a difficulty to vehicle operators.

4. The method of claim 1, wherein the image of the prescribed route of travel includes a portion of a navigational chart.

5. The method of claim 1, wherein the method is performed before the vehicle operator attempts to navigate the prescribed route of travel.

6. The method of claim 1, wherein the method is performed after the vehicle operator has attempted to navigate the prescribed route of travel.

7. The method of claim 1, wherein the vehicle is an aircraft and the vehicle operator is an aircraft pilot.

8. A method of making a simulated flight phase familiarization video, the method comprising:
selecting a simulated location and a simulated aircraft on a computer flight simulator;
selecting a route of travel associated with the simulated location, the route of travel including a prescribed procedure;
setting at least one of a position, altitude, heading, and airspeed of the simulated aircraft in accordance with the route of travel;
providing input to the computer flight simulator for executing the flight phase in accordance with the prescribed procedure; and
recording a graphical output of the flight simulator as a digital moving image.

9. The method of claim 8, wherein the prescribed procedure is an approach to an airport or a departure from an airport.

10. The method of claim 8, wherein providing input includes providing at least one of global positioning system coordinates, flight management system data, manual control through an input device, and autopilot settings.

11. The method of claim 8, further comprising selecting a time of day and a weather condition in the computer flight simulator.

12. The method of claim 8, further comprising creating a video using a movie editing tool, the video including the digital moving image and an audio narrative.

13. The method of claim 8, further comprising creating a video using a movie editing tool, the video including the digital moving image and a still image.

14. A familiarization tool for familiarizing a pilot with a flight phase of a prescribed route of travel, the familiarization tool comprising:
a video recording of a video output of a computer simulation of the flight phase, the computer simulation including images corresponding to an input causing a simulated aircraft to execute the flight phase in accordance with the prescribed route of travel; and
an audio recording, time-synchronized with the video recording, and having remarks relating to the flight phase.

15. The familiarization tool of claim 14, further comprising a graphical image of the prescribed route of travel.

16. The familiarization tool of claim 14, wherein the input includes manual input by a human operator of a flight simulator.

17. The familiarization tool of claim 14, wherein the video recording includes a plurality of vantage points.

18. The familiarization tool of claim 14, wherein the prescribed route of travel is an approach or departure procedure for an airport.

19. The familiarization tool of claim 14, wherein the remarks include an indication of an area of the prescribed route of travel that presents a difficulty or danger in flying.

20. The familiarization tool of claim 14, wherein the remarks include an indication of visual cues the pilot may use as an aid in flying the prescribed route of travel.
